(19) United States
(12) Patent Application Publication
(10) Pub. No.: US 2024/0278160 A1
(43) Pub. Date: Aug. 22, 2024

(54) BLACK AIR FILTER OIL COMPOSITION

(71) Applicant: K&N Engineering, Inc., Riverside, CA (US)

(72) Inventor: Steve Williams, Cherry Valley, CA (US)

(73) Assignee: K&N Engineering, Inc., Riverside, CA (US)

(21) Appl. No.: 18/653,672

(22) Filed: May 2, 2024

Related U.S. Application Data
(63) Continuation-in-part of application No. 18/367,240, filed on Sep. 12, 2023.
Application No. 18/367,240 is a continuation of application No. 16/663,227, filed on Oct. 24, 2019, now abandoned.
(60) Provisional application No. 62/751,104, filed on Oct. 26, 2018.

(51) Int. Cl. B01D 46/00; B05D 1/02; B60H 3/06; C08L 23/08; C08L 91/00

(52) U.S. Cl. CPC B01D 46/0035; B60H 3/06; C08L 23/0823; C08L 91/00; B05D 1/025; B05D 2507/00; B05D 2518/00

(57) ABSTRACT

An air filter oil composition is provided for enhancing airflow and filtration of air passing through an air filter. The composition includes a first portion comprising paraffinic oil, a second portion comprising polyalphaolefin (PAO), and a third portion comprising black dye. Applying the air filter oil composition to a cotton air filter material causes tackiness throughout the air filter material, thereby enhancing airflow and filtration of air passing through the air filter. The composition generally is substantially non-reactive, has an excellent oxidation stability, possesses good thermal stability, and retains a suitable viscosity at normal operating temperatures of an automobile engine. In an embodiment, the composition comprises 96.74% paraffinic oil by volume, 3.20% PAO by volume, and 0.06% black dye by volume. A viscosity of the composition at 100 degrees-C. ranges between about 7.2 centistokes and about 7.6 centistokes.

### PRIORITY

This application is a continuation-in-part of U.S. patent application Ser. No. 18/367,240, filed on Sep. 12, 2023, which claims the benefit of and priority to U.S. patent application Ser. No. 16/663,227, filed on Oct. 24, 2019 and U.S. Provisional Application, entitled “Black Air Filter Oil Composition,” filed on Oct. 26, 2018 having application Ser. No. 62/751,104 and U.S. patent application Ser. No. 14/974,092 filed on Dec. 18, 2015, issued as U.S. Pat. No. 10,434,466.

### FIELD

Embodiments of the present disclosure generally relate to the field of air filters. More specifically, embodiments of the disclosure relate to an air filter oil formulation for causing tackiness throughout the air filter material to enhance airflow and filtration of air passing through the air filter.

### BACKGROUND

An air filter designed to remove particulate is generally a device composed of fibrous materials. These fibrous materials may remove solid particulates such as dust, pollen, mold, and bacteria from the air. Air filters are used in applications where air quality is important, notably in building ventilation systems and in automobile engines.

Air filters may be used in automobiles, trucks, tractors, locomotives and other vehicles that use internal combustion engines. Air filters may be used with gasoline engines, diesel engines, or other engines that run on fossil fuels or other combustible substances. Air filters may be used with engines in which combustion is intermittent, such as four-stroke and two-stroke piston engines, as well as other types of engines that take in air so as to burn a combustible substance. For example, air filters may be used with some gas turbines. Filters may also be used with air compressors or in other devices that take in air.

Filters may be made from pleated paper, foam, cotton, spun fiberglass, or other known filter materials. Generally, the air intakes of internal combustion engines and compressors tend to use paper, foam, or cotton filters. Some filters use an oil bath. Air filters for internal combustion engines prevent abrasive particulate matter from entering the engine's cylinders, where it would cause mechanical wear and oil contamination.

A drawback to paper air filters is that they must be thick, or the fibers must be tightly compressed and dense, which makes paper filters restrictive to air flow. Moreover, as a paper filter becomes more and more clogged with contaminants, the pressure inside the filter drops while the atmospheric air pressure outside the filter remains the same. When the pressure differential becomes too great, due to clogging, contaminants may be pulled through the restricted air filter into the engine. Thus, the performance of a paper air filter (i.e. air flow through the filter and its ability to protect the engine) decreases over the course of the filter's service life.

As will be appreciated by those skilled in the art, one way to reduce the clogging tendency of an air filter is by using a filter material having larger openings between the various fibers comprising the filter material. Of course, a more porous filter material may allow smaller particulate matter to pass through the air filter material, unless the fibers comprising the filter material are sufficiently tacky to cause smaller contaminants to cling to the fibers rather than passing through the air filter. Various oils are known to attract airborne contaminants. However, an oil suitable for use with an air filter must be relatively non-reactive, have an excellent oxidation stability, possess good thermal stability, and retain suitable viscosity at high operating temperatures typical of automobile engines. What is needed, therefore, is a suitably formulated filter oil composition for causing tackiness throughout the air filter material so as to enhance airflow and filtration of intake air to an automobile engine.

### SUMMARY

An air filter oil composition and methods are provided for enhancing airflow and filtration of air passing through an air filter. The composition includes a first portion comprising paraffinic oil, a second portion comprising polyalphaolefin (PAO), and a third portion comprising black dye. Applying the air filter oil composition to a cotton air filter material causes tackiness throughout the air filter material, thereby enhancing airflow and filtration of air passing through the air filter. The composition generally is substantially non-reactive, has an excellent oxidation stability, possesses good thermal stability, and retains a suitable viscosity at normal operating temperatures of an automobile engine. In an embodiment, the composition comprises 96.74% paraffinic oil by volume, 3.20% PAO by volume, and 0.06% black dye by volume. A viscosity of the composition at 100 degrees-C. ranges between substantially 7.2 centistokes (cSTs) and 7.6 cSTs.

In an exemplary embodiment, an air filter oil composition for causing tackiness throughout an air filter material to enhance airflow and filtration of air flowing through the air filter material comprises: a first portion comprising paraffinic oil by volume of the composition; a second portion comprising polyalphaolefin by volume of the composition; and a third portion comprising black dye by volume of the composition.

In another exemplary embodiment, the composition is substantially non-reactive, has an excellent oxidation stability, possesses good thermal stability, and retains a suitable viscosity within a temperature range typical of an operating automobile engine. In another exemplary embodiment, the composition has a viscosity at 100 degrees-C. ranging between substantially 7.2 cSTs and 7.6 cSTs.

In another exemplary embodiment, the composition comprises paraffinic oil ranging between 95.00% and 98.00% by volume, polyalphaolefin ranging between 1.00% and 4.00% by volume, and black dye ranging between 0.04% and 1.00% by volume. In another exemplary embodiment, the composition comprises 96.74% paraffinic oil by volume, 3.20% polyalphaolefin by volume, and 0.06% black dye by volume.

In another exemplary embodiment, the composition is configured to be applied to the air filter material by way of an aerosol spray. In another exemplary embodiment, the composition is configured to be applied to the air filter material by way of a squeeze bottle.

In an exemplary embodiment, a method for an air filter oil composition for enhancing filtration of air flowing through an air filter material comprises: providing a first portion of paraffinic oil and a second portion of polyalphaolefin; mixing the first portion with the second portion to form a mixture; applying a third portion comprising black dye to the mixture to form a composition; and configuring the composition to be applied to the air filter material.

In another exemplary embodiment, mixing includes providing the second portion such that the composition comprises polyalphaolefin ranging between 1.00% and 4.00% by volume. In another exemplary embodiment, applying includes providing the third portion to the mixture such that the composition comprises black dye ranging between 0.04% and 1.00% by volume. In another exemplary embodiment, applying includes providing the third portion to the mixture such that the composition comprises 96.74% paraffinic oil by volume, 3.20% polyalphaolefin by volume, and 0.06% black dye by volume.

In another exemplary embodiment, configuring includes configuring the composition to be applied to the air filter material by way of an aerosol spray. In another exemplary embodiment, configuring includes configuring the composition to be applied to the air filter material by way of a squeeze bottle.

In an exemplary embodiment, a method for enhanced filtration of an airstream comprises: configuring an air filter comprising a filter material that exhibits minimal resistance to the airstream; formulating an air filter composition that causes tackiness throughout the filter material; applying the air filter composition to the filter material; and causing the airstream to flow through the filter material.

In another exemplary embodiment, formulating comprises: providing a first portion of paraffinic oil and a second portion of polyalphaolefin; mixing the first portion with the second portion to form a mixture; applying a third portion comprising black dye to the mixture to form a composition; and configuring the composition to be applied to the air filter material. In another exemplary embodiment, applying includes providing the third portion to the mixture such that the composition comprises 96.74% paraffinic oil by volume, 3.20% polyalphaolefin by volume, and 0.06% black dye by volume.

In another exemplary embodiment, configuring includes sandwiching multiple layers of cotton gauze between two screens to form the filter material. In another exemplary embodiment, applying includes using an aerosol spray to apply the air filter composition to the filter material. In another exemplary embodiment, applying includes using a squeeze bottle to apply the air filter composition to the filter material. In another exemplary embodiment, causing comprises positioning the air filter within a ventilation system which circulates air within an enclosed space.

In an exemplary embodiment, a composition for a filter oil solvent comprises: a first portion comprising a solvent; a second portion comprising one or more grease and stain removers, surfactants, and caustic cleaners; and a third portion comprising one or more dispersants and emulsifiers, and at least one chelating agent.

In another exemplary embodiment, the solvent comprises about 87.90%, by volume, of the composition. In another exemplary embodiment, the solvent comprises any one or more of water, ethanol, isopropanol, and any combination thereof.

In another exemplary embodiment, the one or more grease and stain removers comprise an alkalinity agent, a dispersing agent, a scale and corrosion inhibitor, a stain remover, and a degreaser. In another exemplary embodiment, the one or more grease and stain removers comprise about 5.37%, by volume, of the composition. In another exemplary embodiment, the one or more grease and stain removers comprise any one or more of sodium metasilicate, sodium carbonate, sodium bicarbonate, potassium silicate, and tetrapotassium pyrophosphate. In another exemplary embodiment, the one or more grease and stain removers comprise non-phosphate builders such as citrates, carbonates, bicarbonates, any other chelating agent, and any combination thereof.

In another exemplary embodiment, the surfactants comprise Brij® 010 at a concentration of about 3.25%, by volume, of the composition. In another exemplary embodiment, the surfactants comprise a mixture of a first Brij surfactant having a high hydrophilic/lipophilic balance and a second Brij surfactant having a low hydrophilic/lipophilic balance. In another exemplary embodiment, the surfactants comprise any one or more of Tween surfactants, Span surfactants, Triton surfactants, Tergitol surfactants, and any combination thereof. In another exemplary embodiment, the Tween surfactants comprise either or both of Tween 20 and Tween 80 while the Span surfactants comprise either or both of Span 20 and Span 80. In another exemplary embodiment, the Triton surfactant comprises Triton X-100 while the Tergitol surfactant comprises Tergitol NP-9.

In another exemplary embodiment, the caustic cleaners comprise a caustic cleaning agent at a concentration of about 2.60%, by volume, of the composition. In another exemplary embodiment, the caustic cleaners comprise any one or more of sodium hydroxide, potassium hydroxide, one or more enzyme-based cleaning agents, ammonia or ammonium hydroxide, and any combination thereof.

In another exemplary embodiment, the dispersants and emulsifiers serve as any one or more of a water softener, a dispersing agent, an emulsifier, and a buffer. In another exemplary embodiment, the dispersants and emulsifiers comprise about 0.58%, by volume, of the composition. In another exemplary embodiment, the dispersants and emulsifiers comprise any one or more of sodium trimetaphosphate, sodium hexametaphosphate, ethylenediaminetetraacetic acid (EDTA), sodium citrate, sodium acetate, and any combination thereof.

In another exemplary embodiment, the chelating agent is configured for chelating metal ions such as calcium and magnesium. In another exemplary embodiment, the chelating agent comprises a concentration of tetrasodium EDTA at about 0.30%, by volume, of the composition. In another exemplary embodiment, the chelating agent comprise any one or more of sodium citrate, sodium gluconate, sodium malate, sodium polyacrylate, and any combination thereof.

In an exemplary embodiment, a method for a filter oil solvent comprises: providing a first portion comprising a solvent; forming a second portion comprising one or more grease and stain removers, surfactants, and caustic cleaners; mixing the second portion with the first portion to create a mixture; forming a third portion comprising one or more dispersants and emulsifiers, and at least one chelating agent; and mixing the third portion with the mixture to create a composition.

In another exemplary embodiment, providing the first portion includes providing a quantity of the solvent comprising about 87.90%, by volume, of the composition. In another exemplary embodiment, providing the first portion includes comprising the solvent of any one or more of water, ethanol, isopropanol, and any combination thereof.

In another exemplary embodiment, forming the second portion includes comprising the one or more grease and stain removers of an alkalinity agent, a dispersing agent, a scale and corrosion inhibitor, a stain remover, and a degreaser. In another exemplary embodiment, forming the second portion includes providing a quantity of the one or more grease and stain removers comprising about 5.37%, by volume, of the composition. In another exemplary embodiment, forming the second portion includes comprising the one or more grease and stain removers of any one or more of sodium metasilicate, sodium carbonate, sodium bicarbonate, potassium silicate, and tetrapotassium pyrophosphate. In another exemplary embodiment, forming the second portion includes comprising the one or more grease and stain removers of non-phosphate builders such as citrates, carbonates, bicarbonates, any other chelating agent, and any combination thereof.

In another exemplary embodiment, forming the second portion includes comprising the surfactants of Brij® 010 at a concentration of about 3.25%, by volume, of the composition. In another exemplary embodiment, forming the second portion includes comprising the surfactants of a mixture of a first Brij surfactant having a high hydrophilic/lipophilic balance and a second Brij surfactant having a low hydrophilic/lipophilic balance. In another exemplary embodiment, forming the second portion includes comprising the surfactants of any one or more of Tween surfactants, Span surfactants, Triton surfactants, Tergitol surfactants, and any combination thereof. In another exemplary embodiment, the Tween surfactants comprise either or both of Tween 20 and Tween 80 while the Span surfactants comprise either or both of Span 20 and Span 80. In another exemplary embodiment, the Triton surfactant comprises Triton X-100 while the Tergitol surfactant comprises Tergitol NP-9.

In another exemplary embodiment, forming the second portion includes comprising the caustic cleaners of a caustic cleaning agent at a concentration of about 2.60%, by volume, of the composition. In another exemplary embodiment, forming the second portion includes comprising the caustic cleaners of any one or more of sodium hydroxide, potassium hydroxide, one or more enzyme-based cleaning agents, ammonia or ammonium hydroxide, and any combination thereof.

In another exemplary embodiment, forming the third portion includes comprising the dispersants and emulsifiers in the form of any one or more of a water softener, a dispersing agent, an emulsifier, and a buffer. In another exemplary embodiment, forming the third portion includes providing a quantity of the dispersants and emulsifiers comprising about 0.58%, by volume, of the composition. In another exemplary embodiment, forming the third portion includes comprising the dispersants and emulsifiers of any one or more of sodium trimetaphosphate, sodium hexametaphosphate, ethylenediaminetetraacetic acid (EDTA), sodium citrate, sodium acetate, and any combination thereof.

In another exemplary embodiment, forming the third portion includes configuring the chelating agent for chelating metal ions such as calcium and magnesium. In another exemplary embodiment, forming the third portion includes providing a quantity of the chelating agent comprising a concentration of tetrasodium EDTA at about 0.30%, by volume, of the composition. In another exemplary embodiment, forming the third portion includes comprising the chelating agent of any one or more of sodium citrate, sodium gluconate, sodium malate, sodium polyacrylate, and any combination thereof.

These and other features of the concepts provided herein may be better understood with reference to the drawings, description, and appended claims.

### BRIEF DESCRIPTION OF THE DRAWINGS

The drawings refer to embodiments of the present disclosure in which:

FIG. 1 illustrates a perspective ghost-view of an exemplary use environment comprising a ventilation system of a vehicle that includes a cabin air filter which may be treated with a filter oil composition causing tackiness throughout the air filter medium so as to enhance airflow and filtration of air passing through the cabin air filter;

FIG. 2 illustrates a perspective ghost-view of an exemplary embodiment of a ventilation system comprising a cabin air filter which may be treated with a filter oil composition causing tackiness throughout the air filter medium so as to enhance airflow and filtration of air passing through the cabin air filter;

FIG. 3 illustrates an exemplary embodiment of a cabin air filter that may be treated with a filter oil composition causing tackiness throughout the air filter medium so as to enhance airflow and filtration of air passing through the cabin air filter;

FIG. 4 illustrates an exemplary embodiment of a cabin air filter that may be treated with a filter oil composition causing tackiness throughout the air filter medium so as to enhance airflow and filtration of air passing through the cabin air filter; and

FIG. 5 illustrates a list of ingredients comprising an exemplary embodiment of a filter oil solvent for removing an air filter oil composition from a filter medium.

While the present disclosure is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the invention disclosed herein may be practiced without these specific details. In other instances, specific numeric references such as “first portion,” may be made. However, the specific numeric reference should not be interpreted as a literal sequential order but rather interpreted that the “first portion” is different than a “second portion.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

In general, conventional air filters are restrictive to air flow and prone to clogging as more and more contaminants are captured. One way to reduce the clogging tendency of an air filter is by using a filter material having larger openings between the various fibers comprising the filter material, such as one or more layers of cotton. A porous filter material may allow passage of smaller particulate matter unless the fibers comprising the filter material are sufficiently tacky to cause smaller contaminants to cling to the fibers rather than passing through the air filter. Various oils are known to attract airborne contaminants. Embodiments of the present disclosure provide an air filter oil formulation for causing tackiness throughout air filter materials to enhance airflow and filtration of air passing through air filters. The embodiments disclosed herein provide a filter oil formulation that is relatively non-reactive, has an excellent oxidation stability, possesses good thermal stability, and retains suitable viscosity at high operating temperatures typical of automobile engines.

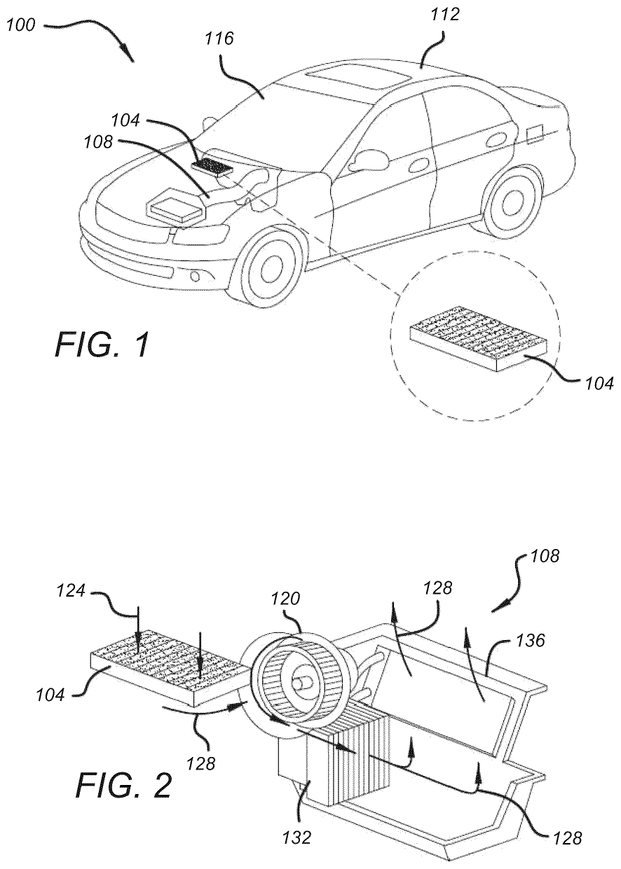

FIG. 1 illustrates an exemplary use environment 100 wherein a cabin air filter 104 is incorporated into a ventilation system 108 of a vehicle 112 so as to clean outside air drawn through the air filter 104 into a passenger compartment 116. It is contemplated that the cabin air filter 104 may be advantageously treated with a filter oil composition that causes tackiness throughout the air filter medium, thereby enhancing airflow and filtration of air passing through the filter 104. As shown in FIG. 2, the ventilation system 108 generally comprises a fan 120 configured to draw an outside air stream 124 through the air filter 104 whereby airborne molecular contaminants, volatile organic compounds, and other particle contaminants are removed from the air stream. Particle contaminants removed from the outside air stream 124 are entrapped in the air filter 104. The fan 120 then pushes a clean air stream 128 into an air conditioning system 132 or a heater core 136 and then into the passenger compartment 116.

It will be appreciated that in some embodiments, the air stream 124 may comprise air drawn from within the passenger compartment 116 rather than outside air. For example, a driver or a passenger may switch the ventilation system 108 to circulate air within the passenger compartment 116, thereby preventing outside air from entering passenger compartment 116. It should be understood, therefore, that in some embodiments the air filter 104 may be implemented so as to remove airborne molecular contaminants, volatile organic compounds, and other particle contaminants from interior air within the passenger compartment 116 being circulated through the ventilation system 108.

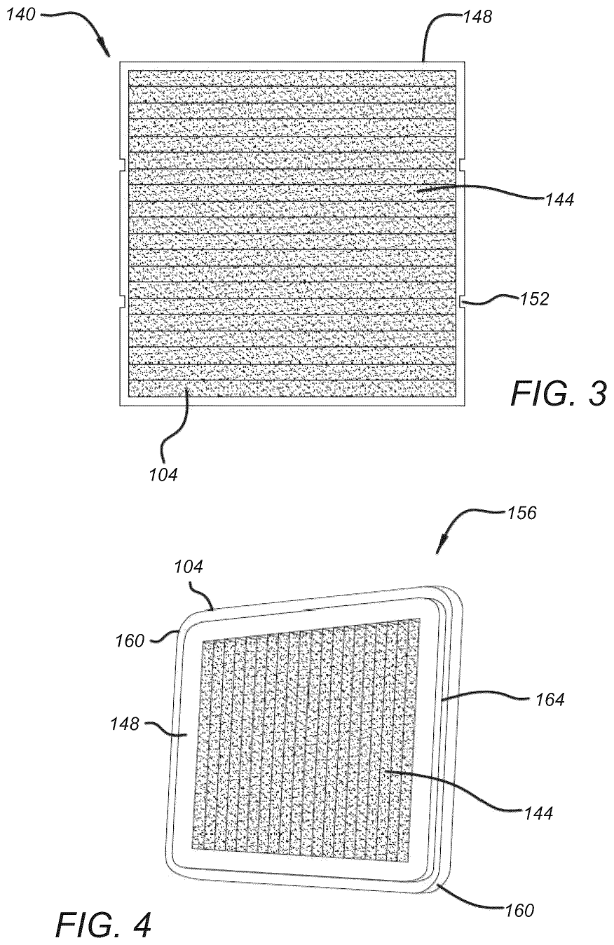

FIG. 3 illustrates an exemplary embodiment 140 of a cabin air filter 104 that may be treated with a filter oil composition that causes tackiness throughout the air filter medium so as to enhance airflow and filtration of air passing through the cabin air filter 104. The cabin air filter 104 generally comprises a filter medium 144 within a supportive frame 148. The supportive frame 148 is configured to orient the cabin air filter 104 within the ventilation system 108 such that the air stream 124 is directed through the filter medium 144. As such, the supportive frame 148 comprises a shape and size suitable for supporting the cabin air filter 104 within the ventilation system 108. It will be appreciated that the shape and size of the supportive frame 148 will vary depending upon the make and model of the vehicle 112 for which the filter 104 is intended to be used.

The supportive frame 148 may comprise various fastening structures suitably configured for securing the cabin air filter 104 within a particular ventilation system 108. To this end, in the embodiment illustrated in FIG. 3, the supportive frame 148 comprises a plurality of notches 152 configured to interface with protrusions within the ventilation system 108 of the vehicle 112. In another exemplary embodiment 156, illustrated in FIG. 4, the supportive frame 148 comprises rounded corners 160 and a ridge 164 configured to orient the cabin air filter 104 within the ventilation system 108 of a particular make and model of automobile. Further, the supportive frame 148 illustrated in FIG. 4 has a different shape than the shape of the supportive frame illustrated in FIG. 3. It should be understood, therefore, that the various structures and shapes incorporated into the supportive frame 148, and thus the cabin air filter 104 as a whole, will vary depending upon the make and model of the vehicle 112 for which the cabin air filter 104 is intended to be used without detracting from the spirit and scope of the present disclosure.

It will be appreciated that the filter medium 144 generally is retained within the supportive frame 148. It is contemplated that any of a variety of fasteners may be used to retain the filter medium 144 within the supportive frame 148. In some embodiments, the supportive frame 148 may be molded to a wire support of the filter medium 144. In some embodiments, the supportive frame 148 may comprise a crimped portion that folds onto and retains the wire support and the filter medium 144 of the cabin air filter 104. It will be appreciated by those skilled in the art that fastening the filter medium 144 to the supportive frame 148 renders the filter medium 144 irremovable from the supportive frame 148.

It is contemplated that a user of the cabin air filter 104 may periodically clean the filter medium 144 rather than replacing the cabin air filter 104, as is typically done with conventional cabin air filter systems. It is envisioned that the cabin air filter 104 may be removed from the ventilation system 108, the ventilation system 108 cleaned of any debris trapped therein, and then a water hose used to flush contaminants from the filter medium 144, thereby leaving the filter clean and ready for reuse. Wherein the filter medium 144 has been previously treated with a filter oil composition, a filter oil solvent may be used to remove the oil from the filter medium 144. Once the filter medium 144 is completely dry, a suitably formulated filter oil composition may be uniformly applied and allowed to wick into the filter medium 144. The filter oil composition may be applied to the filter medium by way of an aerosol spray or a squeeze bottle, as desired. Various other cleaning methods will be apparent to those skilled in the art without deviating from the spirit and scope of the present disclosure.

In some embodiments, the filter medium 144 comprises 4 to 6 layers of cotton gauze sandwiched between two epoxy-coated aluminum wire screens. The cotton is advantageously treated with the above-mentioned suitably formulated filter oil composition for causing tackiness throughout microscopic strands comprising the filter medium 144. The nature of the cotton allows high volumes of airflow, and when combined with the tackiness of the filter oil composition creates a powerful filtering medium which ensures a high degree of air filtration.

During operation of the ventilation system 108, contaminant particles cling to the fibers within the volume of the filter medium 144 and become part of the filtering medium 144, a process referred to as “depth loading.” It will be appreciated that depth loading allows the cabin air filter 104 to capture and retain significantly more contaminants per unit of area than conventional cabin air filters. Contaminants collected on the surface of the cabin air filter 104 have little effect on air flow during much of the filter's service life because there are no small holes for the contaminants to clog. Contaminant particles are stopped by the layers of cotton gauze and held in suspension by the filter oil composition. Moreover, as the cabin air filter 104 collects an increasing volume of contaminants and debris, an additional form of filtering action begins to take place because the outside air must first pass through the trapped contaminants on the surface of the filter medium 144 before passing through deeper layers within the filter medium 144. In essence, the trapped contaminants begin to operate as a filter material which precedes the filter medium 144. Thus, the cabin air filter 104 continues to exhibit a high degree of air flow and filtration throughout the service life of the filter.

It is contemplated that treating the filter medium 144 with the filter oil composition generally enables the filter medium 144 to capture contaminants by way of interception, whereby contaminants, such as by way of non-limiting example, dirt particles, traveling with the air stream 124 directly contact the fibers comprising the filter medium 144 and are then held in place by the filter oil composition. Larger or heavier particles are generally captured by way of impaction, whereby the inertia or momentum of the particles causes them to deviate from the path of the air stream 124 through the filter medium 144, and instead the particles run straight into the fibers and are captured by the filter oil composition.

Particle contaminants having very small sizes may be captured by way of diffusion. Small particles have been found to be highly affected by forces within the air stream 124 through the filter medium 144. Forces due to velocity changes, pressure changes, and turbulence caused by other particles, as well as interaction with air molecules, generally causes the small particles to follow random, chaotic flow paths through the filter medium 144. Consequently, the small particles do not follow the air stream 124, and their erratic motion causes them to collide with the fibers comprising the filter medium 144 and remain captured by the filter oil composition. Diffusion and the filter oil composition enable the cabin air filter 104 to capture particle contaminants having sizes that are much smaller than the openings between the fibers comprising the filter medium 144. Furthermore, the filter oil composition enables the cabin air filter 104 to capture contaminants throughout the volume of the filter medium 144, rather than only on the surface of the filter as is common with conventional cabin air filters. The multiple layers of cotton fibers comprising the filter medium 144 coupled with the tackiness provided by the filter oil composition provide many levels of contaminant retention, thereby enabling the cabin air filter 104 to hold significantly more contaminants per unit of area of the filter medium 144 than is possible with conventional cabin air filters.

It is contemplated that the filter oil composition of the present disclosure is critical to the enhanced air flow and filtration properties of the cabin air filter 104. Preferably, the filter oil composition comprises an oil formulation which is non-reactive, has an excellent oxidation stability, possesses good thermal stability, and retains suitable viscosity at normal operating temperatures of the ventilation system 108. In some embodiments, the filter oil composition may be a mixture of oils and dyes (to provide color) suitable for enhancing the tackiness of the filter medium 144, such as by way of non-limiting example, paraffinic oils, PAOs, and the like. In general, the filter oil composition comprises a mixture that includes paraffinic oil, PAO, and black dye. The paraffinic oil may range between 95.00% and 98.00% by volume of the mixture. The PAO may range between 1.00% and 4.00% by volume of the mixture, and the black dye may range between 0.04% and 1.00% by volume of the mixture. In one embodiment, the filter oil composition comprises a mixture of 96.74% paraffinic oil by volume, 3.20% PAO by volume, and 0.06% black dye by volume. In some embodiments, the filter oil composition has a viscosity at 100 degrees-C. ranging between substantially 7.2 cSTs and about 7.6 cSTs. It is to be understood that the particular oils and dyes, as well as their colors or viscosities, and their individual concentrations within the filter oil composition may be altered without deviating from the spirit and the scope of the present disclosure.

In some embodiments, the filter oil composition may include a tackifier that is added to a mixture of oils and dyes to enhance the tackiness of the filter medium 144. For example, in some embodiments, the filter oil composition may include PARATAC®, which is a tackifier based on a high molecular weight polyisobutylene (PIB) dissolved in a paraffinic base oil. It is contemplated that PARATAC® can help to prevent the filter oil composition from dripping, spattering, or being wiped off surfaces such as the filter medium 144. It is contemplated that the filter oil composition may comprise a weight percent of PARATAC® ranging between about 0.2% and about 2.0%. In one embodiment, for example, the filter oil composition comprises a mixture that includes a weight percent of PARATAC® of about 0.414% by weight of the filter oil composition. Further, in one embodiment, the filter oil composition comprises a mixture including a weight percent of PARATAC® of about 1.0% by weight of the filter oil composition.

It is contemplated that the filter oil composition may be configured to be applied to the filter medium 144 by way of aerosol and non-aerosol means. For example, in some embodiments, the filter oil composition may be configured to be applied to the filter medium 144 by way of a squeeze bottle or a pump spray bottle. In some embodiments, the filter oil composition is a mixture of a first portion comprising one or more paraffinic base oils, a second portion comprising polyalphaolefin, a third portion comprising a tackifier, and a fourth portion comprising a liquid dye for applying a color to the mixture. In one embodiment, the first portion comprises 78.4% paraffinic oil by weight, such as Safety-Kleen RHT 120, and 16.005% paraffinic oil by weight, such as Safety-Kleen RHT 240. Further, the second portion comprises 5.096% polyalphaolefin by weight, such as Safety-Kleen V534 OCP VM, the third portion comprises 0.414% tackifier by weight, such as PARATAC®, and the fourth portion comprises 0.085% red dye by weight, such as UNISOL® Red HF. In another exemplary embodiment, the first portion comprises 67.977% paraffinic oil by weight (e.g., Safety-Kleen RHT 120), and 31% paraffinic oil by weight (e.g., Safety-Kleen RHT 240), while the second portion is omitted. Continuing, the third portion comprises 1.0% tackifier by weight, such as PARATAC®, the fourth portion comprises 0.023% blue dye by weight, such as D55025 Chromatint® Blue HF Liquid.

As mentioned above, in some embodiments, the filter oil composition may be configured to be applied to the filter medium 144 by way of an aerosol spray. Similar to the embodiments described above, the filter oil composition may comprise a first portion comprising one or more paraffinic base oils, a second portion comprising polyalphaolefin, a third portion comprising a tackifier, and a fourth portion comprising a liquid dye for applying a color to the composition. In one embodiment, the first portion comprises 58.8% paraffinic oil by weight, such as Safety-Kleen RHT 120, and 12% paraffinic oil by weight, such as Safety-Kleen RHT 240. Further, the second portion comprises 3.8% polyalphaolefin by weight, such as Safety-Kleen V534 OCP VM, the third portion comprises 0.3% tackifier by weight, such as PARATAC®, and the fourth portion comprises 0.1% red dye by weight, such as UNISOL® Red HF.

Moreover, embodiments intended for aerosol sprays may comprise between about 15% and about 20%1,1-Difluoroethane 152a, between about 1% and about 3% sodium nitrite, and up to about 3% silicone emulsion. As will be appreciated, 1,1-Difluoroethane 152a, or HFC-152a, is a colorless, odorless gas that may be utilized as a propellant in aerosol sprays. In the case of the filter oil composition, HFC-152a propels the composition out of an aerosol can and onto the filter medium 144. The HFC-152a helps to create a fine mist, which ensures that the filter oil composition is uniformly distributed throughout the filter medium 144.

Sodium nitrite is a well-known fixative and penetrating agent. As such, it is contemplated that sodium nitrite is well suited to stabilize the filter oil composition and prevent it from fading or running once applied to the filter medium 144. The sodium nitrite also helps the filter oil composition to be easily absorbed into the filter medium 144, as well as ensuring that the filter oil composition is distributed substantially uniformly throughout the filter medium 144. Further, sodium nitrite can help the filter oil composition more resistant to the effects of light, heat, and other environmental factors.

Silicone emulsion may be included in the filter oil composition to serve as a binder. It is contemplated that the silicone emulsion operates by forming a thin film on the surface of the filter medium 144, and thus helps to protect the colored dye comprising the filter oil composition from the elements and makes the dye more resistant to fading or running. Further, silicone emulsion is a water-resistant substance that can improve the water repellency of the filter medium 144 once it is treated with the filter oil composition.

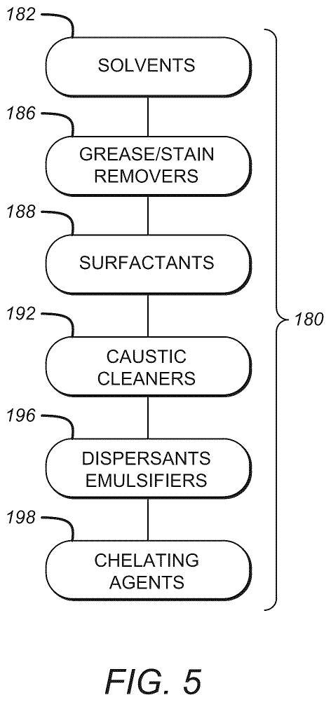

As mentioned hereinabove, the filter medium 144 may be periodically cleaned by way of a filter oil solvent to remove the air filter oil composition and a water hose to flush contaminants from the filter medium 144. The filter material may then be dried, and the air filter oil composition reapplied before the filter is placed back into service. FIG. 5 illustrates a list of ingredients comprising an exemplary embodiment of a filter oil solvent 180 for removing the air filter oil composition from the filter medium 144. The filter oil solvent 180 generally comprises a solvent 182, one or more grease and stain removers 186, one or more surfactants 188, one or more caustic cleaners 192, one or more dispersants and emulsifiers 196, and at least one chelating agent 198. In one exemplary embodiment, the solvent 182 comprises about 87.90%, by volume, of the filter oil solvent 180. The solvent 182 may comprise any one or more of water, ethanol, isopropanol, and any combination thereof, without limitation.

The grease and stain removers 186 generally comprise an alkalinity agent, a dispersing agent, a scale and corrosion inhibitor, a stain remover, and a degreaser. In one exemplary embodiment, the grease and stain removers 186 comprise about 5.37%, by volume, of the filter oil solvent 180. The grease and stain removers 186 may comprise any one or more of sodium metasilicate, sodium carbonate, sodium bicarbonate, potassium silicate, and tetra-potassium pyrophosphate. Further, the grease and stain removers 186 may comprise non-phosphate builders such as citrates, carbonates (e.g., sodium carbonate), bicarbonates (e.g., sodium bicarbonate), other chelating agents, and any combination thereof, without limitation.

In one exemplary embodiment, the surfactants 188 comprise Brij® 010 at a concentration of about 3.25%, by volume, of the filter oil solvent 180. In some embodiments, the surfactants 188 may comprise a mixture of a first Brij surfactant having a high hydrophilic/lipophilic balance (HLB) and a second Brij surfactant having a low HLB. In some embodiments, the surfactants 176 comprise any one or more of Tween surfactants (e.g., Tween 20 [polysorbate 20] and Tween 80 [polysorbate 80]), Span surfactants (e.g., Span 20 [sorbitan monolaurate] and Span 80 [sorbitan monooleate]), Triton surfactants (e.g, Triton X-100 [octylphenol ethoxylate]), Tergitol surfactants (e.g., Tergitol NP-9 [nonylphenol ethoxylate]), and any combination thereof, without limitation.

In one exemplary embodiment, the caustic cleaners 192 comprise a caustic cleaning agent at a concentration of about 2.60%, by volume, of the filter oil solvent 180. In some embodiments, the caustic cleaners 192 comprise any one or more of sodium hydroxide, potassium hydroxide, one or more enzyme-based cleaning agents (e.g., protease enzymes, lipase enzymes, and mixtures thereof), ammonia or ammonium hydroxide (less preferred due to off gassing of ammonia), and any combination thereof, without limitation.

The dispersants and emulsifiers 196 generally serve as a water softener, a dispersing agent, an emulsifier, and a buffer. In one exemplary embodiment, the dispersants and emulsifiers 196 comprise about 0.58%, by volume, of the filter oil solvent 180. In some embodiments, the dispersants and emulsifiers 196 comprise any one or more of sodium trimetaphosphate, sodium hexametaphosphate, ethylenediaminetetraacetic acid (EDTA), sodium citrate, sodium acetate, and any combination thereof, without limitation.

The chelating agent 198 generally is configured for chelating metal ions such as calcium and magnesium. In one exemplary embodiment, the chelating agent 198 comprises a concentration of tetrasodium EDTA at about 0.30%, by volume, of the filter oil solvent 180. In some embodiments, the chelating agent 198 may comprise any one or more of sodium citrate, sodium gluconate, sodium malate, sodium polyacrylate, and any combination thereof, without limitation.

Methods provided herein for an air filter oil composition may, in some embodiments, comprise providing a first portion comprising one or more paraffinic base oils by percent weight of the composition. The one or more paraffinic base oils may, in some embodiments, comprise a first paraffinic base oil and a second paraffinic base oil. In some embodiments, the first paraffinic base oil comprises about 78.4% by weight of the composition and the second paraffinic base oil comprises about 16.005% by weight of the composition. In some embodiments, the first paraffinic base oil comprises about 67.977% by weight of the composition and the second paraffinic base oil comprises about 31% by weight of the composition. Further, in some embodiments, the first paraffinic base oil comprises about 58.8% by weight of the composition and the second paraffinic base oil comprises about 12% by weight of the composition.

The methods provided herein may include providing a second portion comprising polyalphaolefin by percent weight of the composition. The second portion may, in some embodiments, comprise about 5.096% polyalphaolefin by weight of the composition. In some embodiments, the second portion may comprise about 3.8% polyalphaolefin by weight of the composition.

In some embodiments, the methods provided herein may include providing a third portion comprising a tackifier for enhancing filtration of an airstream flowing through a filter medium. The third portion may comprise, in some embodiments, between about 0.3% and about 1.0% tackifier by weight of the composition. In one embodiment, the third portion comprises 0.414% tackifier by weight of the composition.

Further, in some embodiments, the methods provided herein may include providing a fourth portion comprising a liquid dye by percent weight of the composition. In some embodiments, the fourth portion may comprise 0.1% liquid dye by weight of the composition. In some embodiments, the fourth portion may comprise 0.085% liquid dye by weight of the composition. Further, in some embodiments, the fourth portion may comprise 0.023% liquid dye by weight of the composition.

The methods provided herein may include mixing a filter oil composition comprising about 78.4% of a first paraffinic base oil by weight, about 16.005% of a second paraffinic base oil by weight, about 5.096% polyalphaolefin by weight, about 0.414% tackifier by weight, and about 0.085% liquid dye by weight of the composition. In some embodiments, the composition may comprise about 67.977% of a first paraffinic base oil by weight, about 31% of a second paraffinic base oil by weight, about 1.0% tackifier by weight, and about 0.023% liquid dye by weight of the composition. Further, in some embodiments, the composition may comprise about 58.8% of a first paraffinic base oil by weight, about 12% of a second paraffinic base oil by weight, about 3.8% polyalphaolefin by weight, about 0.3% tackifier by weight, and about 0.1% liquid dye by weight of the composition.

Moreover, in some embodiments, the first paraffinic base oil may range between about 58% and about 79% by weight of the composition. In some embodiments, the second paraffinic base oil may range between about 12% and about 31% by weight of the composition. In some embodiments, the polyalphaolefin may range between 0% up to about 6% by weight of the composition. Further, in some embodiments, the tackifier may range between about 0.2% and 2.0% by weight of the composition. Further, the liquid dye may, in some embodiments, range between about 0.02% and about 0.5% by weight of the composition.

Methods provided herein for a filter oil solvent 180 may, in some embodiments, include providing a first portion comprising a solvent 182. Providing the first portion may, in some embodiments, include providing a quantity of the solvent 182 comprising about 87.90%, by volume, of the composition. The solvent 182 may, in some embodiments, comprise of any one or more of water, ethanol, isopropanol, and any combination thereof, without limitation.

In some embodiments, methods provided herein include forming a second portion comprising one or more grease and stain removers 186, surfactants 188, and caustic cleaners 192. In some embodiments, forming the second portion includes comprising the one or more grease and stain removers 186 of an alkalinity agent, a dispersing agent, a scale and corrosion inhibitor, a stain remover, and a degreaser. In some embodiments, the one or more grease and stain removers 186 comprise about 5.37%, by volume, of the composition. The one or more grease and stain removers 186 may, in some embodiments, comprise any one or more of sodium metasilicate, sodium carbonate, sodium bicarbonate, potassium silicate, and tetra-potassium pyrophosphate. Further, in some embodiments, the one or more grease and stain removers 186 may comprise any of non-phosphate builders such as citrates, carbonates, bicarbonates, any other chelating agent, and any combination thereof.

In some embodiments, forming the second portion includes comprising the surfactants 188 of Brij® 010 at a concentration of about 3.25%, by volume, of the composition. In some embodiments, the surfactants 188 may comprise a mixture of a first Brij surfactant having a high hydrophilic/lipophilic balance and a second Brij surfactant having a low hydrophilic/lipophilic balance. In some embodiments, the surfactants 188 may comprise of any one or more of Tween surfactants, Span surfactants, Triton surfactants, Tergitol surfactants, and any combination thereof. The Tween surfactants may, in some embodiments, comprise either or both of Tween 20 and Tween 80 while the Span surfactants may, in some embodiments, comprise cither or both of Span 20 and Span 80. In some embodiments, the Triton surfactant comprises Triton X-100 while the Tergitol surfactant comprises Tergitol NP-9.

Further, in some embodiments, forming the second portion may include comprising the caustic cleaners 192 of a caustic cleaning agent at a concentration of about 2.60%, by volume, of the composition. The caustic cleaners 192 may, in some embodiments, comprise of any one or more of sodium hydroxide, potassium hydroxide, one or more enzyme-based cleaning agents, ammonia or ammonium hydroxide, and any combination thereof.

Methods provided herein for a filter oil solvent 180 may, in some embodiments, further include forming a third portion comprising dispersants and emulsifiers 196, and at least one chelating agent 198. The dispersants and emulsifiers 196 may, in some embodiments, comprise any one or more of a water softener, a dispersing agent, an emulsifier, and a buffer. In some embodiments, the dispersants and emulsifiers 196 may comprise about 0.58%, by volume, of the composition. The dispersants and emulsifiers 196 may, in some embodiments, comprise of any one or more of sodium trimetaphosphate, sodium hexametaphosphate, ethylenediaminetetraacetic acid (EDTA), sodium citrate, sodium acetate, and any combination thereof.

In some embodiments, forming the third portion includes configuring the chelating agent 198 for chelating metal ions such as calcium and magnesium. In some embodiments, the chelating agent 198 may comprise a concentration of tetrasodium EDTA at about 0.30%, by volume, of the composition. The chelating agent 198 may, in some embodiments, comprise of any one or more of sodium citrate, sodium gluconate, sodium malate, sodium polyacrylate, and any combination thereof.

It should be understood that the filter oil composition of the present disclosure is not limited to being applied to the cabin air filter 104, but rather the filter oil composition of the present disclosure may be used with air filters configured for any enclosed space wherein passengers, drivers, as well as occupants reside, such as by way of non-limiting example, automobiles, trucks, recreational vehicles, buses, earthmoving equipment and tractors with enclosed cabins, crane operator cabins, various cargo moving vehicles, locomotives, rail passenger cars, airplanes, helicopters, ship cabins, airship cabins, and the like. Moreover, the filter oil composition of the present disclosure is not to be limited to air filters used in vehicles, but the filter oil composition may be applied to filters configured for use in buildings and detached residential homes. For example, the cabin air filter 104 may be incorporated into a heating, ventilation, and air conditioning (HVAC) system so as to clean interior air being circulated within, or outside air being drawn into, a building or a residential home. It should be understood, therefore, that the filter oil composition of the present disclosure may be used with air filters configured for use with rooftop HVAC systems, central HVAC systems, wall-mounted HVAC systems, as well as portable HVAC systems, and the like.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. To the extent there are variations of the invention, which are within the spirit of the disclosure or equivalent to the inventions found in the claims, it is the intent that this patent will cover those variations as well. Therefore, the present disclosure is to be understood as not limited by the specific embodiments described herein, but only by scope of the appended claims.

What is claimed is:

1. A composition for a filter oil solvent, comprising:
a first portion comprising a solvent;
a second portion comprising one or more grease and stain removers, surfactants, and caustic cleaners; and
a third portion comprising one or more dispersants and emulsifiers, and at least one chelating agent.

2. The composition of claim 1, wherein the solvent comprises about 87.90%, by volume, of the composition.

3. The composition of claim 2, wherein the solvent comprises any one or more of water, ethanol, isopropanol, and any combination thereof.

4. The composition of claim 1, wherein the one or more grease and stain removers comprise an alkalinity agent, a dispersing agent, a scale and corrosion inhibitor, a stain remover, and a degreaser.

5. The composition of claim 1, wherein the one or more grease and stain removers comprise about 5.37%, by volume, of the composition.

6. The composition of claim 5, wherein the one or more grease and stain removers comprise any one or more of sodium metasilicate, sodium carbonate, sodium bicarbonate, potassium silicate, and tetrapotassium pyrophosphate.

7. The composition of claim 5, wherein the one or more grease and stain removers comprise non-phosphate builders such as citrates, carbonates, bicarbonates, any other chelating agent, and any combination thereof.

8. The composition of claim 1, wherein the surfactants comprise Brij® 010 at a concentration of about 3.25%, by volume, of the composition.

9. The composition of claim 8, wherein the surfactants comprise a mixture of a first Brij surfactant having a high hydrophilic/lipophilic balance and a second Brij surfactant having a low hydrophilic/lipophilic balance.

10. The composition of claim 8, wherein the surfactants comprise any one or more of Tween surfactants, Span surfactants, Triton surfactants, Tergitol surfactants, and any combination thereof.

11. The composition of claim 10, wherein the Tween surfactants comprise either or both of Tween 20 and Tween 80 while the Span surfactants comprise either or both of Span 20 and Span 80.

12. The composition of claim 10, wherein the Triton surfactant comprises Triton X-100 while the Tergitol surfactant comprises Tergitol NP-9.

13. The composition of claim 1, wherein the caustic cleaners comprise a caustic cleaning agent at a concentration of about 2.60%, by volume, of the composition.

14. The composition of claim 13, wherein the caustic cleaners comprise any one or more of sodium hydroxide, potassium hydroxide, one or more enzyme-based cleaning agents, ammonia or ammonium hydroxide, and any combination thereof.

15. The composition of claim 1, wherein the dispersants and emulsifiers serve as any one or more of a water softener, a dispersing agent, an emulsifier, and a buffer.

16. The composition of claim 15, wherein the dispersants and emulsifiers comprise about 0.58%, by volume, of the composition.

17. The composition of claim 16, wherein the dispersants and emulsifiers comprise any one or more of sodium trimetaphosphate, sodium hexametaphosphate, EDTA, sodium citrate, sodium acetate, and any combination thereof.

18. The composition of claim 1, wherein the chelating agent is configured for chelating metal ions such as calcium and magnesium.

19. The composition of claim 18, wherein the chelating agent comprises a concentration of tetrasodium EDTA at about 0.30%, by volume, of the composition.

20. The composition of claim 19, wherein the chelating agent comprise any one or more of sodium citrate, sodium gluconate, sodium malate, sodium polyacrylate, and any combination thereof.
